(19) United States
(12) Patent Application Publication
(10) Pub. No.: US 2002/0117161 A1
(43) Pub. Date: Aug. 29, 2002

(54) High horsepower concrete saw with narrow footprint

(75) Inventor: Donald F. Meister, Overland Park, KS (US)

Correspondence Address: Joseph B. Bowman, SHOOK, HARDY & BACON L.L.P., 1200 Main Street, Kansas City, MO, 64105-2118, US

(73) Assignee: Diamant Boart, Inc.

(21) Appl. No.: 09/793,282

(22) Filed: Feb. 26, 2001

(51) Int. Cl. B28D 1/04

(52) U.S. Cl. 125/13.01

(57) ABSTRACT

A self-propelled concrete saw capable of developing at least 50 horsepower and having a narrow footprint for maneuvering in tight spaces. Mounted on the frame of the saw is an automotive style or industrial in-line engine having a crankshaft fitted with a flywheel, a transmission pulley, and a power train drive sprocket. Also mounted on the frame is a power train including a jack shaft assembly operatively connected to a cutting blade assembly. A flexible, positive drive linkage interconnects the power train drive sprocket to the jack shaft assembly to deliver rotative power from the engine respectively to the jack shaft assembly and to the cutting blade assembly.

### BACKGROUND OF THE INVENTION

This invention relates to an industrial concrete saw for cutting and grooving concrete slabs. More specifically, this invention relates to a high horsepower concrete saw with a narrow footprint to permit cutting and grooving operations within confined spaces.

In the concrete industry, when constructing bridges, buildings, roads and the like, it is often necessary to pour large horizontal slabs of concrete. Once poured, it is necessary and desirable to cut the slab for various purposes. This may include cutting seams completely through the slab in order to form expansion joints and to allow for foundation shifting, or to cut small grooves partially into the slab to control stress cracks as the slab cures. Various types of concrete saws may be utilized to carry out these tasks depending upon the size and complexity of the job. For large construction applications, heavy self-propelled saws are used which are normally powered by a gasoline or diesel internal combustion engine mounted on the frame of the saw. When performing a cut, an operator walks behind the saw to control the direction, cutting speed, cutting depth and the like.

High horsepower concrete saws are those generally having a rating in excess of 50 horsepower. Not surprisingly, this class of equipment is in widespread use and is preferred by the concrete construction industry. Higher power, however, has necessarily resulted in equipment of increasing size and complexity. When industrial saws of this genre are used in large open areas, such as on roadways and bridges, the size of the equipment is of little consequence. However, if cutting operations are to be conducted in confined spaces, then obstacles, narrow passages and doorways present navigational obstructions when the cutting equipment exceeds the critical dimension defined by the narrowest passage through which the equipment must pass. Accordingly, a dilemma arises between the higher power saws desired by the contractors and the small size dictated by the obstacles encountered during cutting and grooving operations.

The requirement of operating within confined spaces accordingly limits either the horsepower rating or the type power plant which can be installed on the frame of the industrial concrete saw. Heretofore, such limitations have prevented the use of automotive style and industrial in-line engines in excess of 50 horsepower. Because of the side load on the drive shaft of this class of engine when used on a concrete saw, an outboard bearing has been required which naturally increases the dimensions of the equipment. Otherwise, the engines required have been of such extreme sizes as to completely prevent operations in confined spaces and tight quarters.

A need remains in the construction industry for a high horsepower industrial concrete saw powered by an automotive style or industrial, in-line engine capable of operating within confined spaces and around obstacles. It is an object of the present invention to meet this need and to overcome the dimensional limitations heretofore experienced with high horsepower concrete cutting equipment.

### SUMMARY OF THE INVENTION

More specifically, an object of the invention is to provide an industrial concrete saw capable of developing at least 50 horsepower which can be maneuvered around obstacles and in confined spaces.

Another object of the invention is to provide an industrial concrete saw of the character described having a power unit of an automotive style or industrial gasoline or diesel in-line engine.

An additional object of the invention is to provide a concrete saw of the character described wherein side loads on the work shaft of the engine are minimized to eliminate the need for an outboard bearing, thereby reducing the overall width required for the saw.

Yet another object of the invention is to provide a concrete saw of the character described whereby power from the engine is positively and effectively transferred from the crankshaft thereof to the power train of the cutting blade.

A further object of the invention is to provide an industrial concrete saw capable of developing at least 50 horsepower which can pass between obstructions separated by a critical width of approximately 30 inches as might typically be represented by a conventional door opening.

In summary, a self-propelled concrete saw capable of developing at least 50 horsepower and having a narrow footprint for maneuvering in tight spaces. Mounted on the frame of the saw is an automotive style or industrial in-line engine having a crankshaft fitted with a flywheel, a transmission pulley, and a power train drive sprocket. Also mounted on the frame is a power train including a jack shaft assembly operatively connected to a cutting blade assembly. A flexible, positive drive linkage interconnects the power train drive sprocket to the jack shaft assembly to deliver rotative power from the engine respectively to the jack shaft assembly and to the cutting blade assembly.

Other and further objects of the invention, together with the features of novelty pertinent thereto, will appear in the description of the drawings.

### BRIEF DESCRIPTION OF THE DRAWINGS

In the following description of the drawings, in which like reference numerals are employed to indicate like parts in the various views:

FIG. 1 is a side elevational view of an industrial concrete saw constructed in accordance with a preferred embodiment of the invention.

FIG. 2 is a top plan view of the concrete saw;

FIG. 3 is a front elevational view of the concrete saw;

FIG. 4 is a perspective view of those elements of the concrete saw forming the power train from the internal combustion engine to the blade shaft;

FIG. 5 is a side elevational view of the power train;

FIG. 6 is a top plan view of the power train;

FIG. 7 is a front elevational view of the power train;

FIG. 8 is an enlarged fragmentary view showing a portion of the pattern of ridges and grooves on the power train sprocket, the jack shaft drive sprocket and the flexible drive belt;

FIG. 9 is a front elevational view of the jack shaft assembly in the power train;

FIG. 10 is an end elevational view taken along line 10-10 of FIG. 9 in the direction of the arrows; and

FIG. 11 is an end elevational view taken along line 11-11 of FIG. 9 in the direction of the arrows.

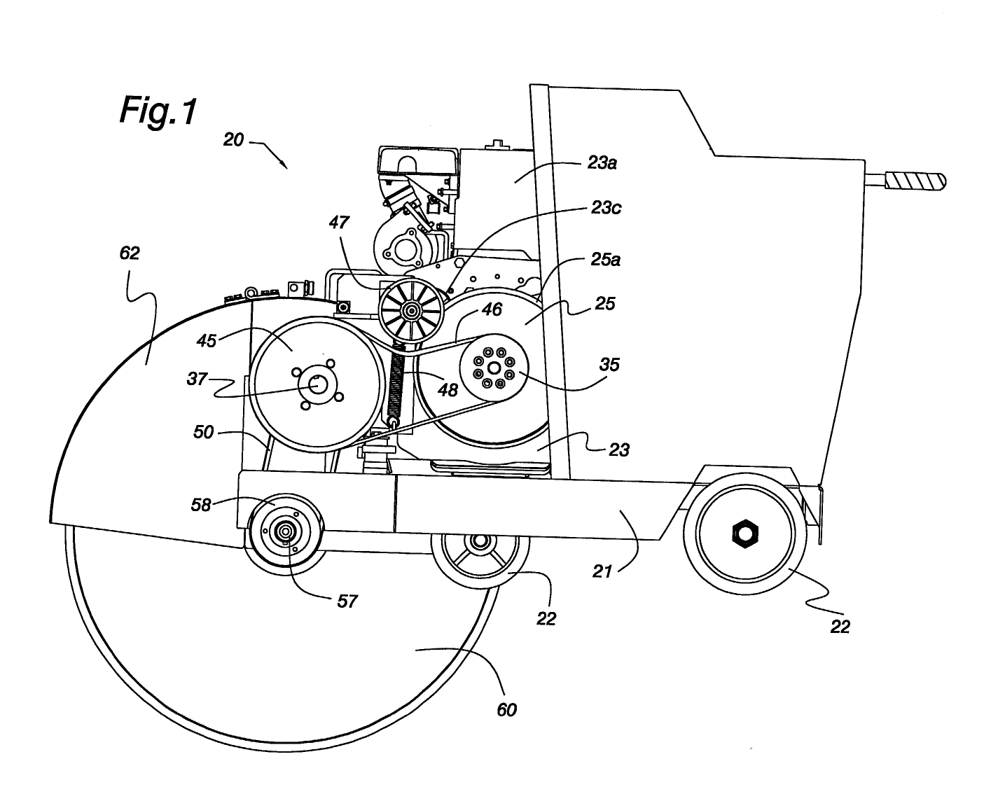

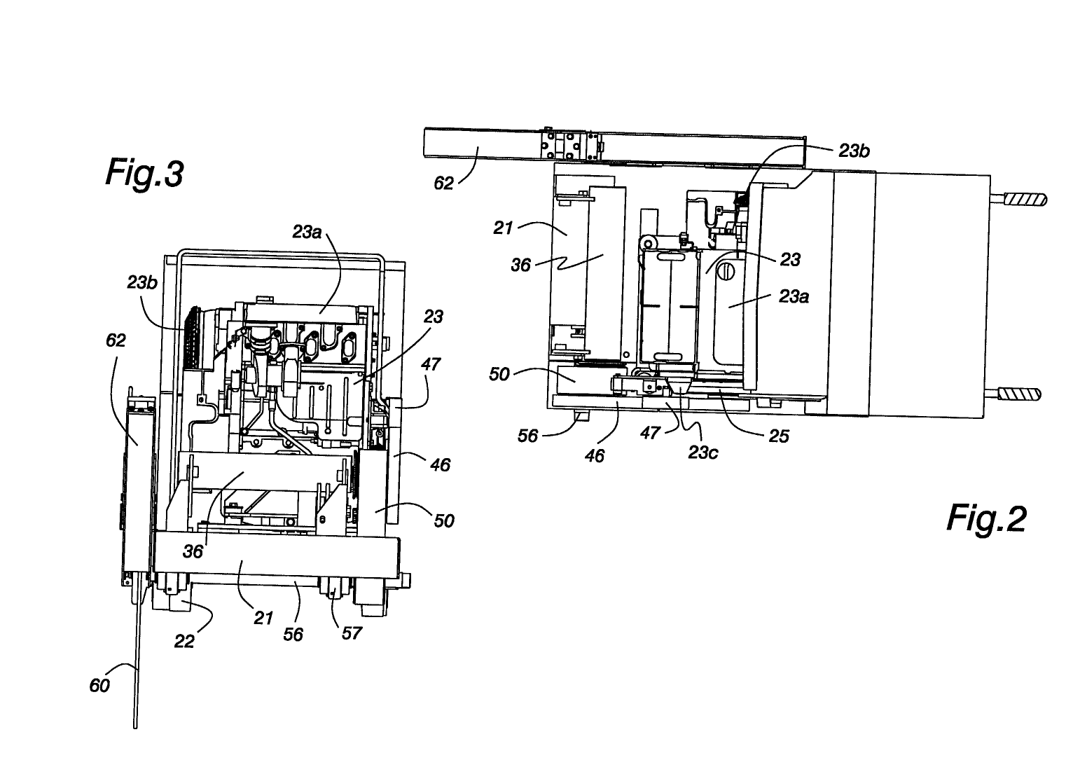

### DETAILED DESCRIPTION OF THE DRAWINGS

Referring to the drawings in greater detail, the industrial concrete saw, indicated generally by the numeral 20, constructed in accordance with this invention includes a frame 21 supported by ground engaging drive wheels 22. General details for construction and operation of industrial concrete saws to which is invention may be adapted are found in U.S. Pat. No. 5,809,985, issued Sep. 22, 1998 and entitled “SelfPropelled Saw,” U.S. Pat. No. 5,743,247, issued Apr. 28, 1998 and entitled “Method and Apparatus for Safe Operation of Self Propelled Concrete Saw,” and U.S. Pat. No. 4,664,645, issued May 12, 1987 and entitled “Blade Drive Shaft Assembly,” all of which are incorporated by reference herein.

An internal combustion engine 23 having in-line cylinders is mounted transversely on the frame 21. Generally speaking, the engine 23 provides power both to rotate the saw blade and to operate, through a transmission, the drive wheels 22 which propel the concrete saw 20. The engine 23 itself is a conventional and commercially available, automotive style or industrial in-line gasoline or diesel engine as might be used to power an automobile or piece of industrial equipment. It will be understood, therefore, that the engine 23 includes conventional features normally associated with such power plants, like a fuel tank 23a, a water or air cooling circulation system 23b, an electric starter 23c, a starting battery, a carburetor or fuel injection system and the like.

Most importantly for the purposes of this invention, the engine 23 includes a crankshaft (not shown) which coterminates substantially with the end of the engine block and which is rotatably driven upon operation of the engine. Since the engine 23 is transversely mounted on the frame 21, the overall length of the engine 23 is critical and represents the major feature determinative of the width of the concrete saw 20. The engine 23 preferably falls in the range of 21 to 24 inches in overall length as measured from one end to the opposite, crankshaft end. In a commercial embodiment of the concrete saw 20, the engine 23 is approximately 21 ⅝ inches in length. It should be noted that the preferred range of 21 to 24 inches does not include the length of any exterior power transmission components which, as will been seen, are secured to the crankshaft. Likewise, it is important that the engine 23 be capable of developing at least 50 horsepower in order to be suitable for the cutting and grooving operations associated with an industrial concrete saw.

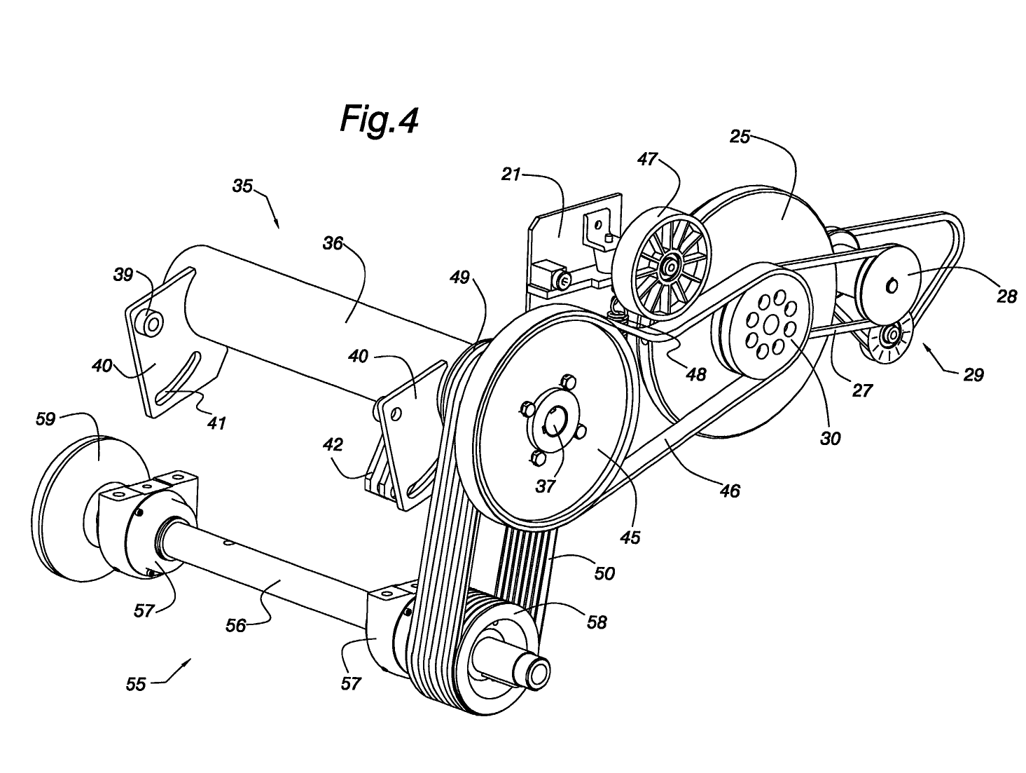

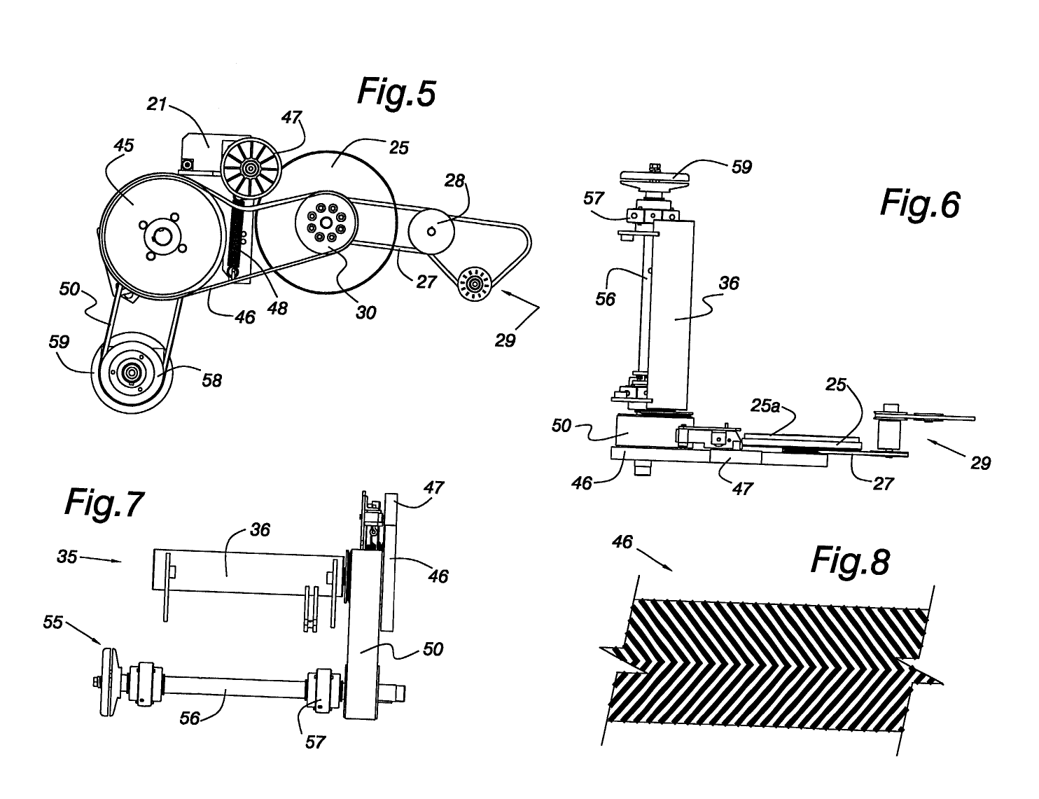

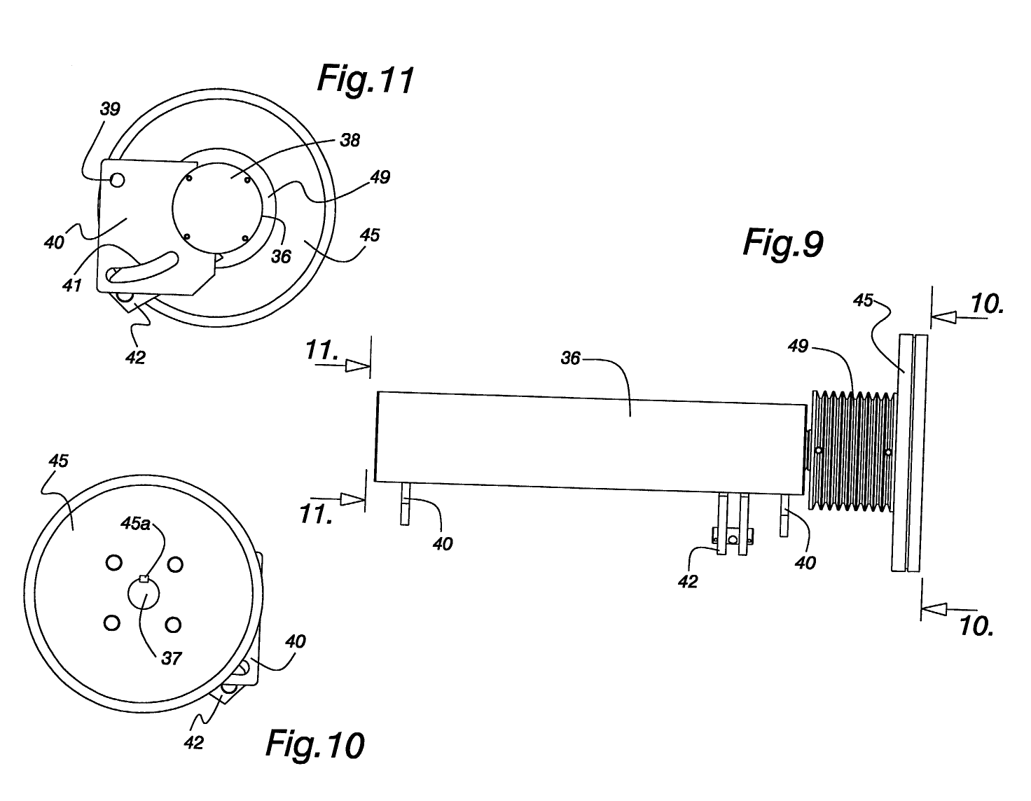

Secured directly to the end of the crankshaft of the engine 23 is a flywheel 25 which includes, as a portion thereof, a ring gear 25a engagable in conventional fashion with a battery powered starter 23c. Outwardly of the flywheel 25 and bolted thereto is a pulley 26 around which is trained a v-belt 27 or other cogged positive displacement belt in order to transmit rotational power a transmission pulley 28 of a transmission assembly 29 (of which only a portion is illustrated in FIG. 4) which controls rotation of the ground engaging drive wheels 22. Outwardly of the transmission pulley 26, a power train sprocket 30 is bolted through the transmission pulley 26 directly to the flywheel 25. The outermost side of the sprocket 30 thereby defines the outermost dimension of the power plant defined by the engine 23 and the power transmission components secured to the crankshaft of the engine 23.

In order to minimize side load on the engine 23, inasmuch as an outboard bearing is specifically eliminated in the configuration of this invention, it is necessary and desirable to limit the overall length of the power plant. The power plant for which length is a consideration includes the engine 23 itself as previously mentioned, together with the flywheel 25, transmission pulley 26, and power train sprocket 30. The latter components must be maintained as narrow as possible while, at the same time, providing maximum power output from the engine 23 to the power train assembly to be subsequently described.

Accordingly, the width of the flywheel 25 preferably falls in the range of 1 to 3inches. In a commercial embodiment of the concrete saw 20, the flywheel 25 is approximately 1⅜ inches in width. The power train sprocket 30 width may preferably range from about ⅝ inches to 2¼ inches. In a commercial embodiment of the concrete saw 20, the power train sprocket 30 is approximately 1¼ inches in width.

The transmission pulley 26 is an optional feature described herein and illustrated in the drawings depending upon whether the concrete saw 20 includes engine power to the ground engaging wheels 22. Although unusual for an industrial concrete saw, the transmission and, consequently, the transmission pulley 26 could be eliminated if the concrete saw was designed to be pushed by the operator rather than travel by engine power. The transmission pulley 26 could also be eliminated, but the transmission and power driven wheels retained, by connecting the transmission to an auxiliary power takeoff on the engine. Assuming the desirability of including the transmission pulley 26, it can preferably range from about ⅜ to 1 inch in width. In a commercial embodiment of the concrete saw 20, the transmission pulley 26 is approximately ⅝ inch in width.

It should be understood that the foregoing ranges for the length of engine 23, and the widths of the flywheel 25, transmission pulley 26 if present, and the power train sprocket 30 are believed to represent preferred working ranges for the components in order to provide a concrete saw 20 with a narrow footprint to fit between obstacles such as, for example, narrow passages. For the purposes of this invention, the critical dimension through which the concrete saw 20 must pass falls in the range of 24 to 30 inches. Accordingly, the foregoing component dimensions must sum to an overall width falling within the critical dimension range. If one or more of the components are at or near their individual maximum dimensions, then the remaining additive components will have to be adjusted accordingly such that the combined overall width of the equipment permits maneuvering with confined spaces.

Secured to the frame 21 of the concrete saw 20 is an adjustably tensionable, jack shaft assembly 35 which is transversely mounted. The jack shaft assembly 35 includes a cylindrical housing 36 through which a jack shaft 37 extends and is held at each end by bearings 38. The cylindrical housing 36 is mounted to the frame 21 for limited pivotable movement by pivot sleeves 39 on brackets 40. The brackets 40 include arcuate slots 41 which receive locking bolts (not shown) to secure the housing 36 to the frame 21 in a preselected position. A tensioning bracket 42 is also attached to the housing 36 to aid in the positioning and tensioning of the jack shaft assembly 35.

So configured and mounted on the frame 21, the jack shaft 37 itself is spaced apart from and parallel to the rotational axis of the flywheel 25 attached to the crankshaft of the engine 23. Accordingly, the outermost end of the jack shaft 37 terminates in substantial lateral alignment with the outermost end of the power train sprocket 30. A jack shaft drive sprocket 45 is mounted on the outermost end of the jack shaft 37 and is locked thereto with a square key 45a. Trained around the power train sprocket 30 and around the jack shaft drive sprocket 45 is a flexible, positive drive linkage belt 46. As illustrated in FIG. 8, in order to minimize the width of the power train sprocket 30 while providing maximum power output, the linkage belt 46 preferably includes v-shaped ridges and grooves continuously around the interior drive surface thereof. These v-shaped ridges and grooves match corresponding v-shaped ridges and grooves in both the power train sprocket 30 and jack shaft sprocket 45. This arrangement causes the linkage belt 46 to be self centering on the power train sprocket 30 and jack shaft sprocket 45 without the need of having a side engaging rim or abutting surface to contain the edges of the belt 46. In other words, the belt 46 of this construction has no tendency to wander or migrate to either the inside or outside edge of either the power train sprocket 30 and jack shaft sprocket 45.

Mounted on the frame 21 is a spring biased, movable idler pulley 47 which registers above the upper loop of the linkage belt 46. A spring 48 is connected to the idler pulley 47 at one end and to the frame 21 of the concrete saw 20 at the opposite end in order to pull the idler pulley 47 to engagement with the linkage belt 46 in order to hold the belt 46 in tension over the power train sprocket 30 and jack shaft sprocket 45. Alternatively, an idler may be fixed with respect to the power train sprocket 30 and jack shaft sprocket 45, or eliminated completely so long as the belt 46 is operatively tensioned on the power train sprocket 30 and jack shaft sprocket 45.

Inboard of the jack shaft sprocket 45 and keyed to the jack shaft 37 are mounted a plurality of side-by-side gang pulleys 49 over which is trained a plurality of v-belts 50 connected to the cutting blade assembly 55.

The cutting blade assembly 55 includes a blade shaft 56 transversely secured to the frame 21 by bearing mounts 57. The blade shaft 56 is oriented parallel with the jack shaft 37 and with the rotational axis of the flywheel 25 and spaced apart for both such components. Pinned to one end of the blade shaft 56 is a plurality of gang pulleys 58 in alignment with the gang pulleys 49 on the jack shaft 37 to receive the v-belts 50 trained there around.

The opposite end of the blade shaft 56 extends beyond the width of the frame 21 to receive a blade hub 59 for removably securing a large diameter abrasive or diamond cutting blade 60. A removable blade guard 62 is connected to the frame 21 and provides a safety shield around the upper half of the saw blade 60.

Constructed in accordance with the foregoing, therefore, the most critical width dimension of the concrete saw 20 is defined by the blade shaft 56 itself. If the concrete saw 20 is not otherwise narrow enough to fit between obstacles within confined spaces, then the blade guard 62 may be removed from the frame 21 of the concrete saw 20 in order to reduce the equipment to its narrowest overall width dimension.

Operation of the engine 23 rotatably drives the flywheel 25 which in turn rotates the transmission pulley 26 and power train sprocket 30 secured thereto. The flexible linkage belt 46 trained around the power train sprocket 30 and the jack shaft sprocket 45 rotatably drive the jack shaft 37 itself. The idler pulley 47 engages the linkage belt 46 to ensure engagement of the belt 46 with the power train sprocket 30 and jack shaft sprocket 45. Rotation of the jack shaft 37 correspondingly imparts rotation of the blade shaft 56 by power transferred through the plurality of v-belts 50 trained around the ganged pulleys 49 and 58 which, in turn, drives the saw blade 60 itself

From the foregoing it will be seen that this invention is one well adapted to attain all the ends and objects hereinabove set forth, together with the other advantages which are obvious and which are inherent to the invention.

It will be understood that certain features and subcombinations are of utility and may be employed without reference to other features and subcombinations. This is contemplated by and is within the scope of the claims.

Since many possible embodiments may be made of the invention without departing from the scope thereof, it is understood that all matter herein set forth or shown in the accompanying drawings is to be interpreted as illustrative and not in a limiting sense.

Having thus described my invention, I claim:

1. A self-propelled concrete saw to move between adjacent obstructions separated by a critical width “W”, said concrete saw comprising:
a frame;
wheels connected to said frame to movably support the frame on the surface to be cut;
a blade shaft mounted on said frame;
a saw blade carried on said blade shaft for cutting concrete;
an in-line engine mounted transversely on said frame, said engine having an overall engine length “L1” and being capable of developing at least 50 horsepower delivered to a rotatably powered crankshaft;
a flywheel having a maximum thickness of “T1” secured to the end of said crankshaft;
a drive wheel gear having a maximum thickness of “T2” secured directly to said flywheel;
a flexible, positive drive linkage having a maximum thickness no greater than T2 trained around said drive wheel gear; and
a power translation assembly interconnecting said flexible, positive drive linkage and said blade shaft whereby rotation of said engine crankshaft translates to rotation of said saw blade
wherein the sum of said engine length L1, said flywheel thickness T1, and said drive wheel gear thickness T2 is less than the critical width W through which said concrete saw may move between obstructions.

2. The concrete saw as in claim 1, wherein said critical width W is less than 30 inches.

3. The concrete saw as in claim 2, said overall engine length L1 being less than 24 inches, and the sum of said flywheel thickness T1 and said drive wheel gear thickness T2 being less than 6 inches.

4. The concrete saw as in claim 2, said overall engine length L1 being less than 24 inches, said flywheel thickness T1 being less than 3 inches, and said drive wheel gear thickness T2 being less than 2¼ inches.

5. The concrete saw as in claim 1, said drive wheel gear having sprocket teeth around the perimeter surface thereof and said flexible, positive drive linkage having drive teeth thereon which interlockingly match the sprocket teeth of said drive wheel gear.

6. The concrete saw as in claim 5 wherein said sprocket teeth of said drive wheel gear and said interlocking sprocket teeth of said flexible, positive drive linkage are formed as a V-shaped pattern in order to center said drive linkage on said drive wheel gear.

7. The concrete saw as in claim 5 wherein said drive wheel gear includes drive belt flanges on each side of said sprocket teeth and wherein said sprocket teeth of said drive wheel gear and said interlocking sprocket teeth of said flexible, positive drive linkage are formed as a linear horizontal pattern and said drive belt flanges contain said drive linkage on said drive wheel gear.

8. The concrete saw as in claim 1, said power translation assembly including:
a rotatable jack shaft mounted on said frame;
a jack shaft drive gear mounted on said jack shaft around which said flexible, positive drive linkage is trained whereby rotation of said engine crankshaft imparts rotation to said jack shaft;
a first set of drive belt pulleys carried on said jack shaft;
a second set of drive belt pulleys carried on said blade shaft; and
a plurality of drive belts trained around said first and second sets of drive belt pulleys whereby rotation of said jack shaft imparts rotation to said blade shaft.

9. The concrete saw as in claim 8, wherein said first and second sets of drive belt pulleys are mounted respectively on said jack shaft and said blade shaft inwardly from the sides of said concrete saw.
